(19) United States
(12) Patent Application Publication
(10) Pub. No.: US 2017/0114804 A1
(43) Pub. Date: Apr. 27, 2017

(54) DEVICE FOR RECOVERING HYDRAULIC ENERGY IN AN IMPLEMENT AND A CORRESPONDING IMPLEMENT

(71) Applicant: Liebherr-France SAS, Colmar Cedex (FR)

(72) Inventors: Frank HELBLING, Sasbach (DE); Thomas LANDMANN, Eguisheim (FR)

(21) Appl. No.: 15/332,942

(22) Filed: Oct. 24, 2016

(30) Foreign Application Priority Data
Oct. 23, 2015 (DE) 10 2015 013 768.9
Mar. 18, 2016 (DE) 10 2016 003 390.8

(51) Int. Cl. F15B 1/02; F15B 21/14

(52) U.S. Cl. CPC F15B 1/024; F15B 21/14; F15B 2201/00

(57) ABSTRACT

This present disclosure relates to a device for recovering hydraulic energy in an implement with a mooring pump for operation as pump or as motor, with a high-pressure accumulator and with a throttle differential circuit for connecting the bottom side of a working cylinder with the rod side of the working cylinder of the implement, and to a corresponding implement.

### CROSS REFERENCE TO RELATED APPLICATIONS

This application claims priority to German Patent Application No. 10 2015 013 768.9, entitled “Device for Recovering Hydraulic Energy in an Implement and a Corresponding Implement,” filed Oct. 23, 2015, and this application claims priority to German Patent Application No. 10 2016 003 390.8, filed Mar. 18, 2016, the entire contents of each of which are hereby incorporated by reference in their entirety for all purposes.

### TECHNICAL FIELD

This present disclosure relates to a device for recovering hydraulic energy in an implement and to a corresponding implement itself.

### BACKGROUND AND SUMMARY

In devices for recovering hydraulic energy of implements as they are known from the prior art, it so far is known to utilize working pumps which supply both a boom of the implement and a slewing gear of the implement with hydraulic fluid. For the recovery of hydraulic energy it is known to provide special high-pressure accumulators for the boom and separate therefrom for the slewing gear or pressure accumulators with different operating pressures. In the devices known from the prior art it is disadvantageous that separate actuators and a separate management or a separate regulation/control are required for the exchange of energy between the separate pressure accumulators. It can also be disadvantageous that for the recuperation of energy no differential circuit is provided at the corresponding actuators, so that the utilization of a pump is absolutely necessary for carrying out the recuperation.

It therefore is the object of the present disclosure to provide a generic device which is simpler in construction than the devices known from the prior art and which can be utilized more flexibly and more efficiently than the same.

According to the present disclosure, this object is solved by a device for recovering hydraulic energy in an implement with a mooring pump which can be utilized as pump or as motor, comprising a high-pressure accumulator as well as a throttle differential circuit for connecting the bottom side of a working cylinder with the rod side of the working cylinder of the implement, wherein on lowering of a boom of the implement the hydraulic fluid flowing out of the working cylinder flows into three regions, wherein in the first region the mooring pump operates in the motor mode and drives further consumers, wherein in the second region the high-pressure accumulator stores pressure energy, and wherein in the third region the hydraulic fluid flowing out of the bottom side or the rod side of the working cylinder at least partly fills the respective other side of the working cylinder.

What is meant with the side of the working cylinder either is the rod side or the bottom side of the working cylinder. Further consumers can be all other consumers of an implement. Said construction of the device advantageously ensures that a single high-pressure accumulator can be utilized as common accumulator for a slewing gear and the boom or their actuators. The slewing gear can be driven via the stored energy of the high-pressure accumulator and/or by a slewing gear pump. When braking an uppercarriage of the implement such as for example an excavator uppercarriage, braking energy can be passed from a slewing gear motor or drive, which during braking operates as pump, to the high-pressure accumulator.

Since the working pump is formed as mooring pump and hence also can act as energy recuperation pump, no installation space furthermore advantageously is necessary for an otherwise necessary additional pump. The device according to the present disclosure furthermore represents a simple variant of the recovery of hydraulic energy, which provides for a hybridization of an implement without corresponding recovery device, wherein the uppercarriage construction of the implement need not be changed substantially and a corresponding retrofitting is possible without any problems. The inventive arrangement of the device also means that an only small number of valves as compared to the prior art is required for the recovery of energy.

In a particularly preferred exemplary embodiment it is conceivable that the working cylinder is a boom cylinder of the boom of the implement. When lowering the boom from an elevated position into a lower position, in particular also with loaded boom, a rather large amount of potential energy hence can be recuperated via the energy recovery device. This is due to the fact that in implements the largest use of energy frequently is made in the region of the boom and the loads moved by the same, and hence also the largest amounts of energy can be recuperated.

In another preferred exemplary embodiment it is conceivable that the throttle differential circuit comprises a throttle between the bottom side and the rod side of the working cylinder. The pressure level thereby can be raised advantageously for directly filling the high-pressure accumulator, wherein the bottom side of the cylinder can be connected with the rod side of the cylinder via the differential circuit. To prevent excess pressure on the cylinder bottom side, the connection from the bottom to the rod side can be throttled. At the same time, the oil quantity which flows to the accumulator or to the high-pressure accumulator or to the pump or mooring pump is reduced by about half.

In another preferred exemplary embodiment it is conceivable that the hydraulic fluid in the third region flows from the bottom side into the rod side, and in another preferred exemplary embodiment it is conceivable that the mooring pump operates in an open circuit. In a preferred exemplary embodiment it furthermore is conceivable that the hydraulic fluid flows into one, two or three of the regions at the same time or in parallel. In this way, the energy recovery can flexibly be adjusted in dependence on the generated energy to be recovered and on the energy consumption at other consumers.

In another preferred exemplary embodiment it is conceivable that a hydraulic slewing gear pump is provided for driving a slewing gear of the implement. By such separate pump for driving the slewing gear the boom of the implement can be boosted, even if further parallel movements for example of the slewing gear take place. The high-pressure accumulator likewise can be charged, while at the same time other movements such as for example movements of the slewing gear are controlled in parallel without disturbing these movements.

In another preferred exemplary embodiment it is conceivable that stored energy of the high-pressure accumulator can be transmitted to other pumps and/or to a diesel engine via the slewing gear pump. In general, the energy stored in the high-pressure accumulator can be utilized in the boom and in a slewing gear of the implement to drive corresponding pumps operated as motor. The slewing gear pump correspondingly can advantageously act as motor and supply corresponding units of the diesel engine or directly other pumps of the implement with energy.

Furthermore, it can be provided that in case of failure of the device an emergency function is provided for operating the implement, for example due to the circuit configurations described herein.

The present disclosure also is directed to an implement, in particular to a hydraulic excavator, with a device as described herein.

Further details and advantages of the present disclosure are shown with reference to the Figures.

### BRIEF DESCRIPTION OF THE FIGURES

FIG. 1 shows schematic representations in which a slewing gear pump is operated in a closed circuit.

FIG. 2 shows schematic representations in which a slewing gear pump is operated as mooring pump in an open circuit.

FIG. 3 shows schematic representations in which a slewing gear pump is operated as standard pump in an open circuit.

### DETAILED DESCRIPTION

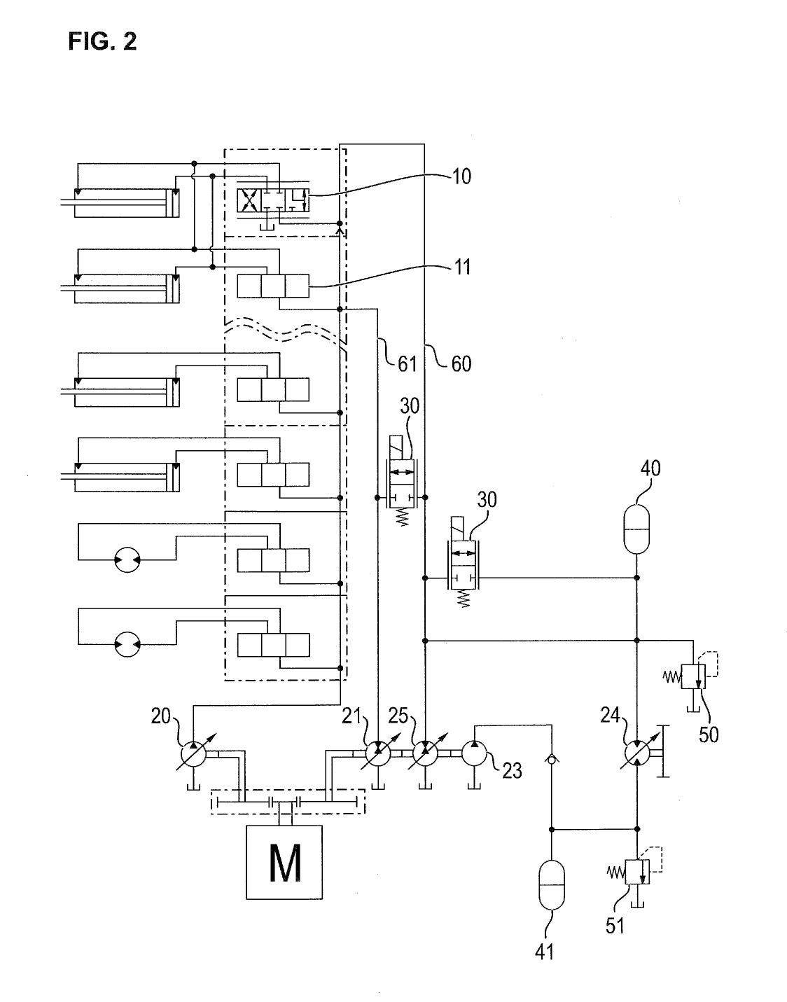

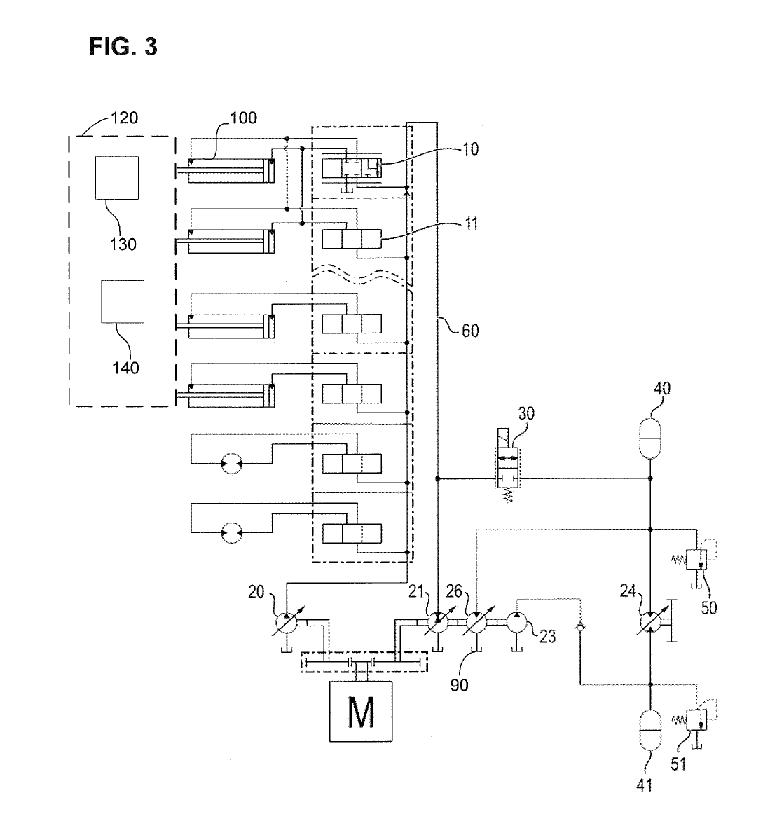

On lowering of the boom 130 of an implement 120, the potential energy of the boom in the form of a correspondingly pressurized oil stream is exploited by the device according to the present disclosure by means of the three-way recuperation effected at three points or regions. This is the same in the embodiments of the three Figures. The device of FIG. 2 differs from the two other devices in that here the hydraulic system of the implement working without slewing gear 140 (e.g. digging work of an excavator without utilization of a slewing gear) can be operated in three independent circuits. The device of FIG. 3 differs from the two other devices in that the slewing gear pump is a standard pump. The same is easier to operate and less expensive than a slewing gear pump in a closed circuit or a mooring pump, but has the disadvantage that it can only be utilized as pump.

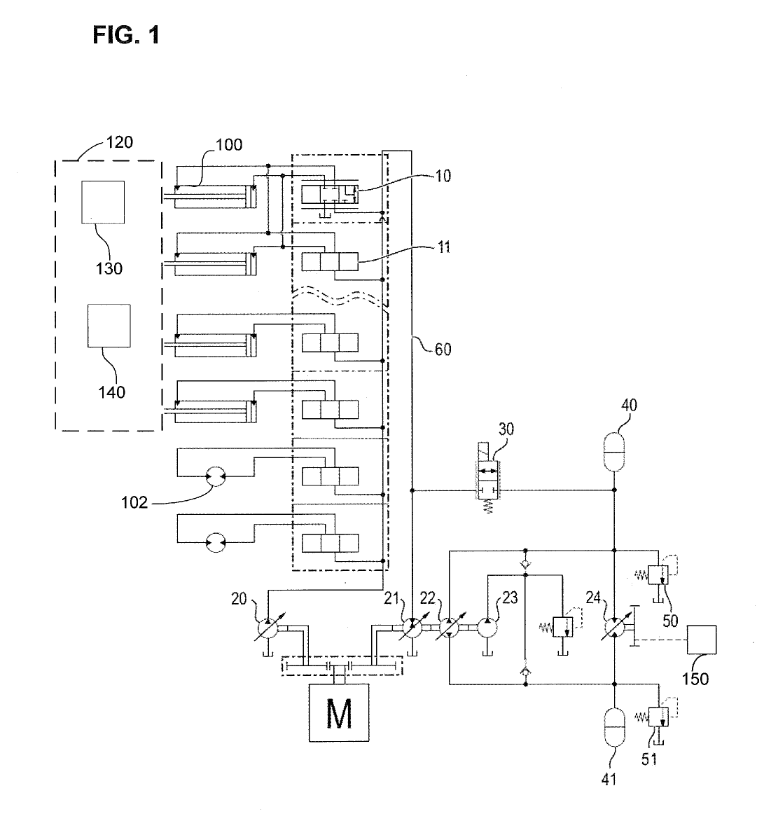

With reference to FIG. 1 the function of the device according to the present disclosure will now be explained in detail.

FIG. 1 shows a device according to the present disclosure in which the oil stream is passed from the bottom side of a working cylinder 100 via the control axis 10 to the rod side of the working cylinder 100. Various cylinders are shown in FIG. 1 as example consumers, along with example reversible direction hydraulic motors 102. The pistons 100 may be coupled to the boom to actuate the boom and/or slewing gears to slew excavator components with respect to one another.

The excess oil is fed into the pump line 60. Feeding on the rod side leads to a pressure increase on the bottom side, which serves the direct accumulator filling of the high-pressure accumulator 40. To prevent excess pressure on the bottom side, the connection to the rod side can be throttled in the control axis 10. The control therefor can be effected electronically. This results in an energy recuperation in the rod side of the working cylinder 100 by the described throttle differential circuit.

According to the present disclosure, an energy recuperation also can be effected by direct filling of the high-pressure accumulator 40. Via the valve axis 30, a partial oil stream can be branched off from the pump line 60 directly for accumulator filling of the high-pressure accumulator 40.

According to the present disclosure, the energy recuperation also can be effected via the mooring pump 21, wherein the entire or a part of the oil stream from the pump line 60 drives the mooring pump 21 which at this time operates as motor. Via a transmission, the energy released is forwarded to other pumps and/or to a diesel engine 150 (having a crankshaft coupled to the motor 24) of the implement, where it correspondingly is exploited further for driving other consumers, for filling accumulators or for compensating a trailing load. The actuation of the standard boom axis 11 provides for a boost on lowering or for a normal operation in case of failure of the recuperation system according to the present disclosure. In the boost mode, the oil stream is passed from the bottom side of the working cylinder 100 via the control axis 11 to the tank. The boom is in free fall. In normal operation, the control axis 11 serves to control the hoisting cylinder. The oil stream is passed from the pump line 60 via the control axis 11 to the hoisting cylinder and the returning oil stream is passed from the hoisting cylinder via the control axis 11 to the tank.

The actuation of the standard boom axis 11 provides for a boost on lowering or for a normal operation in case of failure of the recuperation system according to the present disclosure. The mooring pump 21 operates in the normal pump mode when the boom is not lowered. Depending on the pressure at the hoisting cylinder or at the working cylinder and depending on the desired lowering speed of the boom, an algorithm can determine the path of the recuperation or determine into which regions the hydraulic fluid is passed for carrying out a recuperation. In doing so, several or also all three paths or regions can be chosen at the same time.

An advantage of the device according to the present disclosure with its three different recuperation regions consists in that only a single high-pressure accumulator 40 must or can be utilized and no loss-making energy transmission between different accumulators must be effected. The high-pressure storage also can be effected at any time and due to the separate slewing gear pump 22, 25 can also be carried out in parallel to other working or slewing gear movements. The working pump or mooring pump 21 can supply all consumers and in particular the boom, the dipper arm or also the traveling drive of the implement. The slewing gear pump 22, 25 can be formed as mooring pump 21.

The device according to the present disclosure is particularly efficient, as in the three-way recuperation the oil flow can be split into three paths. The oil flow can flow to the mooring pump 21, to the high-pressure accumulator 40 and to the rod side of the working cylinder 100. The complete oil stream need not flow through the pump, so that the components required for the recuperation, in particular the pump or mooring pump 21, can be dimensioned smaller or more compact and less expensive and as a result smaller pressure losses are obtained in the device. Due to the regions for recuperation formed in three independent hydraulic circuits, a pressure adaptation is superfluous during the recuperation, whereby no pressure losses must be accepted.

The Figure illustrates example configurations of various hydraulic pumps, motors, cylinders, etc. For example, the figures illustrate variable pump. motor 20, pump/motor 23, variable hydraulic pump/motor 24, hydraulic pump/motor 26, accumulator 41, spool valves 50, 51 and parallel pump line 61.

The figures show various hydraulic circuits with certain elements hydraulically coupled in the circuit. The components may be referred to as being positioned upstream or downstream from one another with respect to a direction of hydraulic flow from a high pressure to a low pressure with oil returning to a sump 90 (only labeled once but shown in numerous locations in the example circuits). The components may be referred to a directly upstream or downstream from one another when no other components are positioned therebetween other than the hydraulic line.

In general, this provides the advantages that the high-pressure accumulator 40 can be charged, even if other movements of the implement are controlled in parallel. These movements are not influenced by charging the high-pressure accumulator 40. Furthermore, the boom can be accelerated via a standard piston. The implement, which in particular can be formed as excavator, also can still be operated during malfunctions of the recuperation system, as the illustrated recuperation system represents an add-on solution.

1. A device for recovering hydraulic energy in an implement with a mooring pump for operation as a pump or as a motor, comprising a high-pressure accumulator as well as a throttle differential circuit for connecting the bottom side of a working cylinder with the rod side of the working cylinder of the implement, wherein on lowering of a boom of the implement the hydraulic fluid flowing out of the working cylinder flows into three regions, wherein in a first region a mooring pump operates in a motor mode and drives further consumers, wherein in a second region a high-pressure accumulator stores pressure energy, and wherein in a third region hydraulic fluid flowing out of the bottom side or the rod side of the working cylinder at least partly fills the respective other side of the working cylinder.

2. The device according to claim 1, wherein the working cylinder is a boom cylinder of the boom of the implement.

3. The device according to claim 2, wherein the throttle differential circuit comprises a throttle between the bottom side and the rod side of the working cylinder.

4. The device according to claim 3, wherein the hydraulic fluid in the third region flows from the bottom side into the rod side of the working cylinder.

5. The device according to claim 1, wherein the mooring pump operates in an open hydraulic circuit.

6. The device according to claim 1, wherein the hydraulic fluid flows into at least two of the regions at the same time.

7. The device according to claim 1, wherein the hydraulic fluid flows into at least two of the regions in parallel.

8. The device according to claim 1, wherein the hydraulic fluid flows into at least each of the regions at the same time and in parallel.

9. The device according to claim 1, wherein a hydraulic slewing gear pump is provided for driving a slewing gear of the implement.

10. The device according to claim 9, wherein stored energy of the high-pressure accumulator is transmitted to other pumps.

11. The device according to claim 9, wherein stored energy of the high-pressure accumulator is transmitted to a diesel engine via the slewing gear pump.

12. The device according to claim 9, wherein stored energy of the high-pressure accumulator is transmitted to other pumps and to a diesel engine via the slewing gear pump.

13. The device according to claim 1, wherein in case of failure of the device an emergency function is provided for operating the implement.

14. A method for operating a device for recovering hydraulic energy in an implement with a mooring pump for operation as a pump or as a motor, the device having a high-pressure accumulator as well as a throttle differential circuit for connecting the bottom side of a working cylinder with the rod side of the working cylinder of the implement, the method comprising:
during and on lowering of a boom of the implement, hydraulic fluid flowing out of the working cylinder flows into three regions, wherein in a first region a mooring pump operates in a motor mode and drives further consumers, wherein in a second region a high-pressure accumulator stores pressure energy, and wherein in a third region hydraulic fluid flowing out of the bottom side or the rod side of the working cylinder at least partly fills the respective other side of the working cylinder.

15. The method according to claim 14, wherein the working cylinder is a boom cylinder of the boom of the implement, and wherein only three regions are available to receive fluid flowing out of the working cylinder.

16. The method according to claim 15, wherein the throttle differential circuit comprises a throttle between the bottom side and the rod side of the working cylinder.

17. The method according to claim 16, wherein the hydraulic fluid in the third region flows from the bottom side into the rod side of the working cylinder.

18. The method according to claim 1, wherein the mooring pump operates in an open hydraulic circuit, and wherein the hydraulic fluid flows into at least two of the regions at the same time and in parallel, and wherein stored energy of the high-pressure accumulator is transmitted to a diesel engine via a pump.

19. The method according to claim 14, wherein in case of failure of the device, an emergency function is provided for operating the implement.
